(19) United States
(12) Patent Application Publication
(10) Pub. No.: US 2026/0357833 A1
(43) Pub. Date: Nov. 12, 2026

(54) Quick-release Mechanism and Gimbal with Quick-release Mechanism

(71) Applicant: PGYTECH CO.,LTD, Jiangsu (CN)

(72) Inventors: Lifeng ZHANG, Jiangsu (CN); Shilei ZHU, Jiangsu (CN); Xiuzhi YU, Jiangsu (CN)

(73) Assignee: PGYTECH CO.,LTD, Jiangsu (CN)

(21) Appl. No.: 19/553,522

(22) Filed: Mar. 2, 2026

(30) Foreign Application Priority Data
May 7, 2025 (CN) 202520883747X

(51) Int. Cl. F16B 2/18

(52) U.S. Cl. CPC F16B 2/185

(57) ABSTRACT

The present disclosure discloses a quick-release mechanism and a gimbal with a quick-release mechanism. The quick-release mechanism comprises a clamping seat, a locking tongue slidably provided at the end of the clamping seat, and a trigger block linked with the locking tongue; further comprises a rotating member rotatably arranged relative to the clamping seat, with a locking mechanism provided between the clamping seat and the rotating member; further comprises a quick-release plate assembled on the clamping seat, which, after assembly, presses against the trigger block to release the locking mechanism, allowing the rotating member to rotate along the clamping seat and drive the locking tongue to translate axially during the rotation of the rotating member.

### CROSS-REFERENCE TO RELATED APPLICATIONS

This application claims priority to Chinese Patent Application No. 202520883747X, filed on May 7, 2025, entitled “Quick-release Mechanism and Gimbal with Quick-release Mechanism”, the content of which, including the amendments thereof, is incorporated into this application by reference in its entirety.

### TECHNICAL FIELD

The present disclosure relates to technical fields such as the assembly of quick-release mechanisms and gimbals, and particularly relates to a quick-release mechanism and a gimbal with a quick-release mechanism.

### BACKGROUND

The quick-release mechanisms described in the prior art generally consist of a base, a movable block, a locking block, a quick-release seat, a toggle buckle and the like, and then use the toggle buckle for locking and unlocking. The entire locking and unlocking process requires significant manual effort, and during operation, the toggle is prone to accidental contact, leading to unintended actions and affecting usability.

### SUMMARY

The present disclosure provides a quick-release mechanism and a gimbal with a quick-release mechanism, aiming to solve the problems raised in the background art, such as using a toggle buckle for locking and unlocking, the entire locking and unlocking process requiring significant manual effort, and the toggle being prone to accidental contact during operation, leading to unintended actions and affecting usability.

To achieve the above objective, the present disclosure adopts the following technical solutions:

In one aspect, the present disclosure provides a quick-release mechanism, including a clamping seat, wherein a locking tongue is slidably provided at an end of the clamping seat, and the locking tongue is linked with a trigger block;

further including a rotating member rotatably arranged relative to the clamping seat, wherein a locking mechanism is provided between the clamping seat and the rotating member; and

further including a quick-release plate assembled on the clamping seat, wherein the quick-release plate, after being assembled, presses against the trigger block to release the locking mechanism, enabling the rotating member to rotate along the clamping seat, and during rotation of the rotating member, drives the locking tongue to translate axially.

In another aspect, the present disclosure provides a quick-release mechanism, including: a clamping seat, wherein a locking tongue is slidably provided at an end of the clamping seat, and the locking tongue is linked with a trigger block;

further including a rotating member, wherein a locking mechanism is provided between the clamping seat and the rotating member; and

further including a quick-release plate assembled on the clamping seat, the quick-release plate being used to release the locking mechanism, causing the locking tongue to move axially.

In still another aspect, the present disclosure provides a gimbal, including a gimbal, including a quick-release mechanism and a ball head mechanism, as well as an assembly ring rotatably connected to the quick-release mechanism, wherein the assembly ring is fixedly connected to the ball head mechanism.

The beneficial effects of the present disclosure compared to the prior art are as follows:

In the present disclosure, through the arrangement of the trigger block, the locking mechanism is directly unlocked during the assembly of the quick-release plate, causing the rotating member to rotate, which then drives the locking tongue to move, thereby achieving the locking of the entire quick-release plate on the clamping seat.

In the present disclosure, the locking tongue approaches for locking through translation, whereas in most prior art, the locking tongue is controlled by rotational pressing; such pressing and rotation are prone to accidental contact, leading to unintended triggering and affecting usability, thus the present disclosure enhances user experience.

In the present disclosure, the gimbal, through the arrangement of a pressing block, enables the quick-release mechanism to be locked onto the gimbal; when actually applied to a camera, the pressing block forms a panoramic pressing block, thereby locking usage states such as foreground.

### BRIEF DESCRIPTION OF DRAWINGS

The drawings, which form a part of this application, are provided to further illustrate the present disclosure; the illustrative embodiments and descriptions thereof are used to explain the present disclosure and do not constitute an improper limitation thereof. In the drawings:

FIG. 1 is an assembly drawing of the quick-release mechanism provided by the present disclosure.

FIG. 2 is a schematic structural diagram of the quick-release mechanism provided by the present disclosure.

FIG. 3 is an assembly drawing of the rotating member provided by the present disclosure.

FIG. 4 is an assembly drawing of the first compression spring provided by the present disclosure.

FIG. 5 is an assembly drawing of the locking tongue provided by the present disclosure.

FIG. 6 is a schematic structural diagram of the locking tongue provided by the present disclosure.

FIG. 7 is a schematic structural diagram of the trigger block provided by the present disclosure.

FIG. 8 is a schematic structural diagram of the locking mechanism in an unlocked state provided by the present disclosure.

FIG. 9 is a cross-sectional view of the locking mechanism in an unlocked state provided by the present disclosure.

FIG. 10 is a schematic structural diagram of the locking mechanism in a locked state provided by the present disclosure.

FIG. 11 is a cross-sectional view of the locking mechanism in a locked state provided by the present disclosure.

FIG. 12 is an assembly drawing of the gimbal provided by the present disclosure.

FIG. 13 is a cross-sectional view of the gimbal provided by the present disclosure.

Reference signs: Quick-Release Mechanism (100); Quick-Release Plate (110); Clamping Seat (120); Locking Tongue (121); Step (1211); Locking Tongue Cover Plate (122); Trigger Block (130); Rotating Shaft (131); Rotating Member (140); Interference Part (141); First Compression Spring (142); Second Compression Spring (143); Locking Groove (144); Grip Part (145); Assembly Ring (200); Pressing Block (210); Ball Head Mechanism (300); Lower Cover Plate (310); Driving Mechanism (320).

### DESCRIPTION OF EMBODIMENTS

The technical solutions in the embodiments of the present disclosure will be clearly and completely described below with reference to the accompanying drawings in the embodiments of the present disclosure. It is apparent that the described embodiments are only a part of the embodiments of the present disclosure, rather than all of them. The following description of at least one exemplary embodiment is illustrative only and is in no way intended to limit the present disclosure and its applications or uses. Based on the embodiments of the present disclosure, all other embodiments obtained by those of ordinary skill in the art without creative efforts shall fall within the scope of protection of the present disclosure.

It should be noted that the terms used herein are only for describing specific embodiments and are not intended to limit the exemplary embodiments according to the present application. As used herein, unless the context clearly indicates otherwise, the singular forms are intended to include the plural forms as well. Furthermore, it should be appreciated that when the terms “comprise” and/or “include” are used in this specification, they indicate the presence of features, steps, operations, devices, components, and/or combinations thereof.

Unless specifically stated otherwise, the relative arrangement, numerical expressions, and numerical values of components and steps set forth in these embodiments do not limit the scope of the present disclosure. At the same time, it should be appreciated that for ease of description, the dimensions of the various parts shown in the drawings are not drawn according to actual proportional relationships. Techniques, methods, and equipment known to those of ordinary skill in the relevant art may not be discussed in detail, but where appropriate, such techniques, methods, and equipment should be considered as part of the authorized specification. In all examples shown and discussed herein, any specific values should be construed as illustrative only and not as limiting. Therefore, other examples of the exemplary embodiments may have different values. It should be noted that similar reference numerals and letters denote similar items in the following drawings, so once an item is defined in one drawing, it does not need to be further discussed in subsequent drawings.

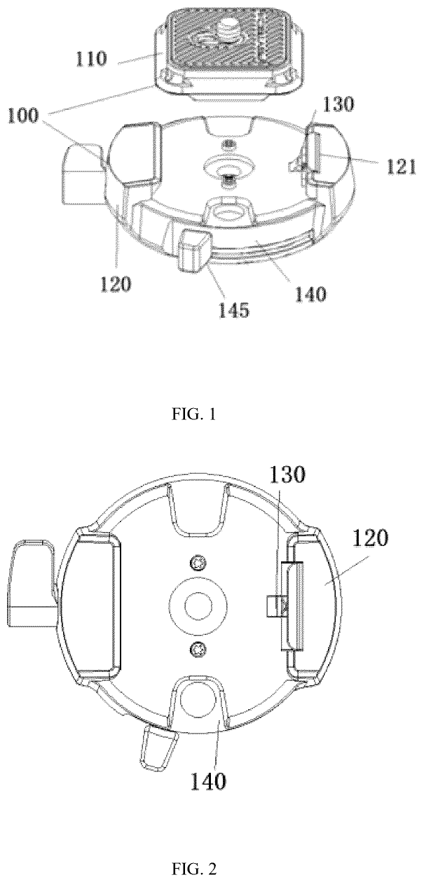

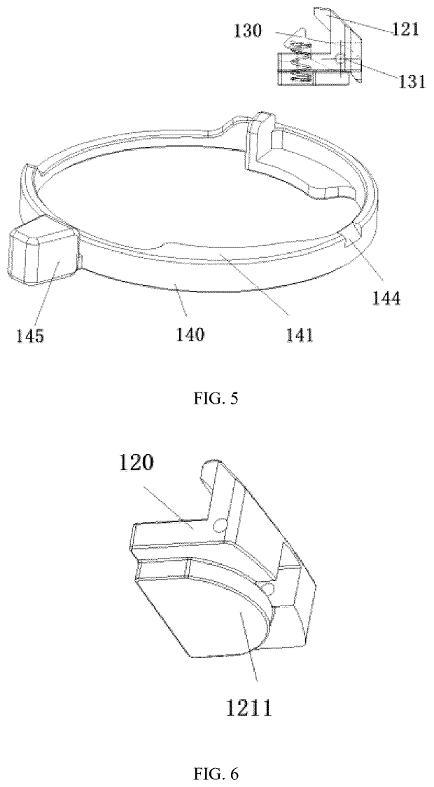

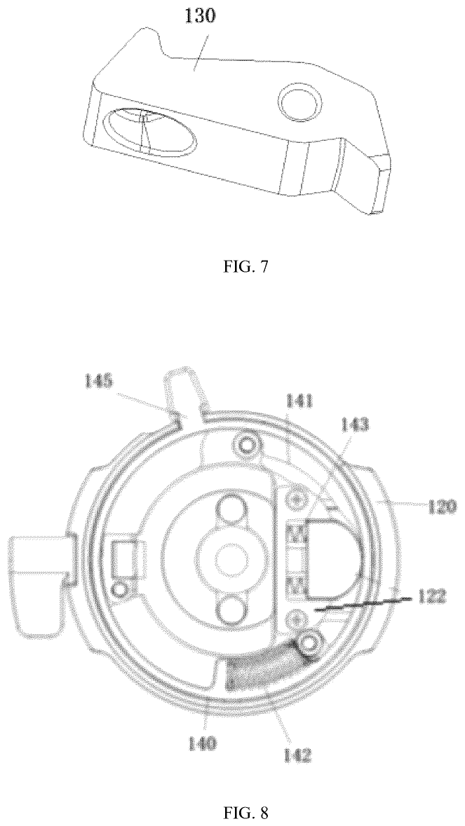

Please refer to FIGS. 1 to 11:

The present disclosure provides a quick-release mechanism and a gimbal with a quick-release mechanism. This embodiment provides a quick-release mechanism and a gimbal with a quick-release mechanism.

Referring to FIGS. 1-11, the quick-release mechanism 100 described in this embodiment includes a clamping seat 120 for clamping a quick-release plate 110 of a subsequently assembled camera. A locking tongue 121 is slidably provided at the end of the clamping seat 120, and the locking tongue 121 is used to lock the quick-release plate 110. However, a trigger block 130 is linked to the locking tongue 121. This embodiment also includes a rotating member 140 that rotates along the clamping seat 120. A locking mechanism is provided between the clamping seat 120 and the rotating member 140 to control the locking or unlocking of the rotating member, enabling it to be locked on the clamping seat or to rotate along the clamping seat. In use, the quick-release plate 110 is assembled on the clamping seat 120. After the quick-release plate 110 is assembled on the clamping seat, it presses against the trigger block 130 to release the locking mechanism, allowing the rotating member 140 to rotate along the clamping seat 120. During the rotation of the rotating member 140, the locking tongue 121 is driven to translate axially. In this embodiment, specifically, a guiding inclined surface is formed on the trigger block 130, which extends from the upper or lower surface of the clamping seat. Here, the guiding inclined surface on the upper surface is utilized to achieve trigger control.

The working principle in this embodiment is as follows:

Compared to locking and unlocking controls using tools like wrenches, before assembly of the quick-release plate 110, the rotating member 140 is locked onto the clamping seat 120 via the locking mechanism and cannot rotate, thereby preventing movement of the interlocking locking tongue. After the quick-release plate is assembled, the trigger block 130 is activated, placing the locking mechanism in an unlocked state. At this point, when the rotating member 140 rotates, it drives the locking tongue 121 to move horizontally to adjust the clamping space, securing and locking the entire quick-release plate 110. This eliminates the need for excessive unlocking control with a wrench, reduces the occurrence of accidental touches, and allows movement of the locking tongue only after the quick-release plate is assembled, making the entire control process simple.

Of course, when the quick-release plate is not assembled, the trigger block may also be controlled by other means, but when applied in a camera, the quick-release mechanism achieves effects such as rapid locking and fixation of the camera.

In this embodiment, the assembly process of the trigger block and the locking tongue is as follows:

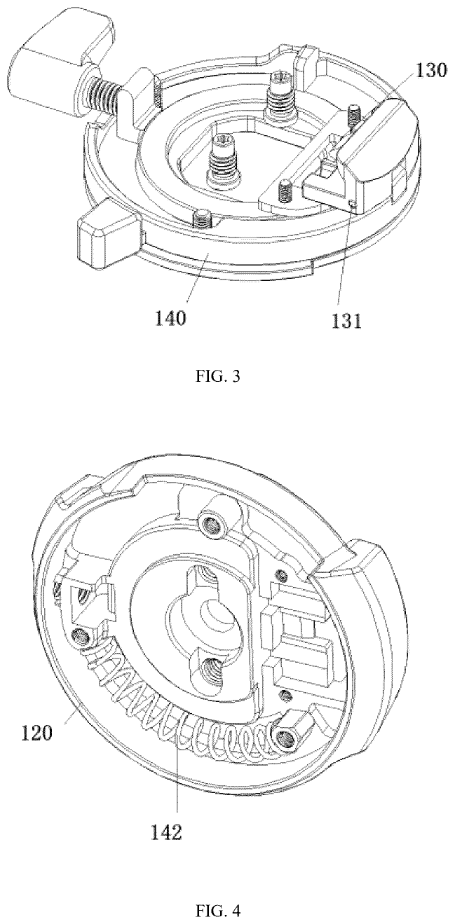

Referring to FIGS. 3 and 5-7, in this embodiment, the trigger block 130 rotates within a certain range in the locking tongue 121. For example, an assembly groove may be formed in the middle of the locking tongue 121, with the trigger block 130 rotationally mounted within the assembly groove and moving reciprocally within a set range. At this time, a limit is formed above the locking tongue 121, thereby restricting the rotation range of the trigger block. For instance, rotation occurs within a range of upward 60° and a range of downward 60°, with the horizontal plane of the locking tongue 121 as the axis. During this rotation, the trigger block 130 is locked onto the rotating member 140 at the bottom of the locking tongue 121, preventing it from rotating and locking—for example, configured like a hook—which will be described in detail later.

To enable rotation of the trigger block, a rotating shaft 131 is added. After passing through the upper perforation in the trigger block 130, both ends of the rotating shaft 131 extend into the two sides inside the locking tongue 121, completing the rotational assembly. At this point, the trigger block 130 forms a lever structure with the rotating shaft 131 as the fulcrum, so that applying external force to either side inside or outside the locking tongue 121 to depress it causes the other side to lift up.

The locking tongue in this embodiment is described as follows:

Referring to FIGS. 3 and 5-6, in this embodiment, the rotating member 140 is a rotating shell structure, and the rotating member 140 extends inward to form an interference part 141. The locking tongue 121 extends downward to form a step 1211. During the rotation of the rotating member 140, the interference part 141 generates an interference force that pushes the step 1211 to move axially. Specifically, the interference part 141 forms an arc-shaped groove on the inner side of the rotating member 140. As the rotating member rotates, the interference part gradually contacts the step 1211. After contact, continued rotation along the curved surface of the interference part enhances the interference effect, thereby causing the interference part to drive the step 1211 inward for horizontal axial movement.

Referring to the figures, the width of the arc-shaped interference part 141 may gradually increase. Thus, along the circumferential direction of the rotating member 140, from one end to the other, due to the increase or decrease in the width of the interference part 141, the interference force of the interference part tends to gradually increase or decrease. In this process, the conversion of force from the rotational circumferential direction to a horizontal directional force is achieved.

Referring to FIG. 4, it also includes a first compression spring 142 that abuts against the clamping seat 120 and the rotating member 140 respectively. The first compression spring 142 forms a driving force that rotates the rotating member 140. That is, before unlocking, the first compression spring 142 is in a compressed state. After unlocking, the reset action of the first compression spring 142 drives the entire rotation of the rotating member 140, creating the driving force.

Referring to FIG. 8, it further includes a second compression spring 143 that abuts against the locking tongue 121 and the clamping seat 120 respectively. The second compression spring 143 forms a driving force when driving the locking tongue 121 to move axially outward. That is, the second compression spring is arranged horizontally. When the locking tongue moves inward to lock the quick-release plate, the second compression spring is compressed. When removing the quick-release plate 110 to unlock the trigger block 130, the reset of the second compression spring causes the locking tongue to move outward.

Referring to FIGS. 8-11, the entire motion process and principle in this embodiment are as follows:

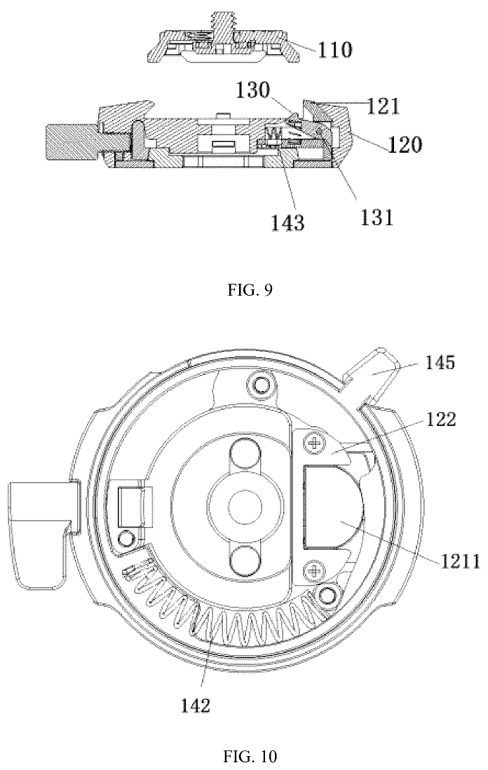

Referring to FIGS. 8-9, before assembling the quick-release plate 110, the entire locking mechanism is in an unlocked state. The first compression spring 142 is compressed between the interference part 141 and a limit post inside the clamping seat 120, while the second compression spring 143 is not under a force and has no effect. The locking tongue 121 is set outward away from the center of the clamping seat 120. The trigger block 130 is located on the outer side of the clamping seat 120; after being pressed down, it is locked with the locking groove 144 in the rotating member 140, preventing the rotating member 140 from rotating.

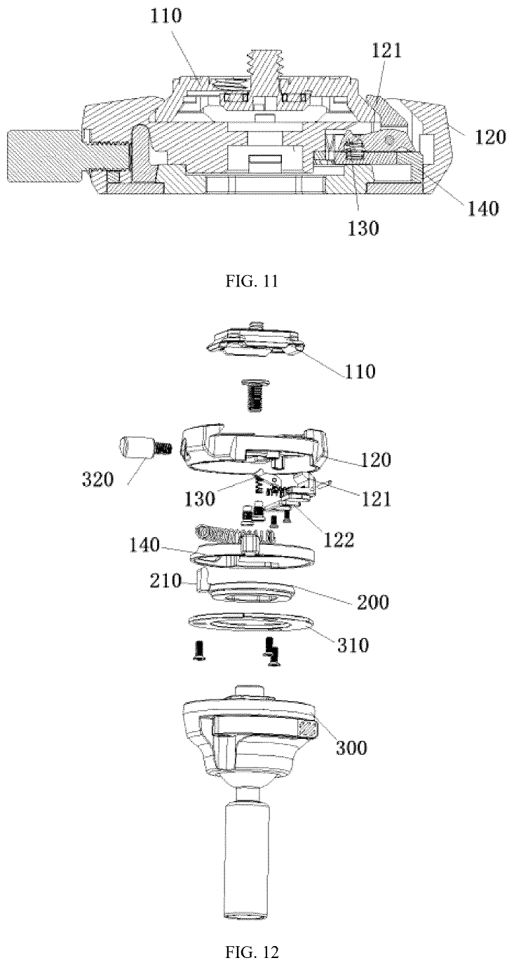

As shown in FIGS. 10-11, after the quick-release plate 110 is assembled, it presses against the upper surface of the trigger block 130, causing the trigger block to be depressed. During this process, the trigger block 130 is depressed at the inner side of the clamping seat 120 while its outer side tilts upward, presenting an unlocked state relative to the locking groove 144. This gives the rotating member 140 a trend to rotate. At this point, the first compression spring 142 resets, driving the rotation of the rotating member 140. The interference part 141 acts to move the locking tongue 121 horizontally to lock the quick-release plate 110, and then the second compression spring 143 is compressed. At this stage, the force of the first compression spring 142 is greater than the sum of the forces of the two symmetrically arranged second compression springs 143, resulting in a stronger resetting action that can drive the rotation.

In the aforementioned process, a locking groove 144 may also be provided at the tail end of the trigger block 130, with a locking hook formed on the outer side of the rotating member 140 to accomplish locking and unlocking.

To assist the locking tongue in sliding and locking horizontally, a locking tongue cover plate 122 fixed to the clamping seat 120 is further included. The locking tongue cover plate 122 forms a sliding trajectory for the axial sliding of the locking tongue 121, thereby ensuring that the locking tongue slides along this trajectory. It can also provide support and limit movement, ensuring sliding accuracy.

According to another embodiment of the present disclosure, referring to FIGS. 1-11, the quick-release mechanism of this embodiment similarly includes a clamping seat 120 for clamping a camera quick-release plate 110, a locking tongue 121 slidably arranged at the end of the clamping seat 120, and a trigger block 130 linked to the locking tongue 121.

This embodiment further includes a rotating member 140 and a locking mechanism arranged between the clamping seat 120 and the rotating member 140. Additionally, it includes a quick-release plate 110 that can be assembled onto the clamping seat 120. The quick-release plate 110 is used to release the locking mechanism after assembly, thereby allowing the locking tongue 121 to move axially to achieve locking or release of the quick-release plate 110.

As a preferred implementation, the rotating member 140 is rotatably arranged on the clamping seat 120. When the quick-release plate 110 is assembled onto the clamping seat 120, it presses against the trigger block 130. This pressing action releases the locking mechanism, thereby unlocking the rotating member 140 and allowing it to rotate relative to the clamping seat 120.

Furthermore, the rotating member 140 extends inward to form an interference part 141, while the locking tongue 121 extends downward to form a step 1211. After the quick-release plate 110 presses the trigger block 130 to release the locking mechanism, the rotating member 140 can be rotated. During its rotation, the interference part 141 interferes with the step 1211 of the locking tongue 121, thereby pushing the locking tongue 121 to translate along its axial direction (i.e., horizontally), thus completing the clamping, locking, or release of the quick-release plate 110.

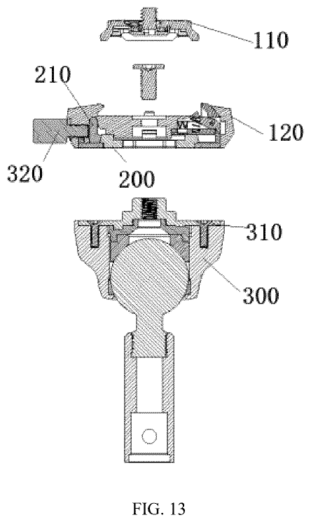

Referring to FIGS. 12-13, this embodiment provides a gimbal, including the quick-release mechanism 100 as described in the above embodiment, and an assembly ring 200 rotatably connected to the quick-release mechanism 100, wherein the assembly ring 200 is fixedly connected to a ball head mechanism 300.

In this embodiment, specifically, a bolt passes through the quick-release plate and the entire quick-release mechanism 100, then is threadedly connected with the ball head mechanism 300 to achieve the rotatable connection. Between the ball head mechanism 300 and the quick-release mechanism 100, a step lap joint is arranged inside the assembly ring 200, achieving both close contact and rotation, among other functions.

As shown in FIGS. 12-13, it also includes a pressing block 210 extending into the clamping seat 120. When the pressing block 210 is forced to rotate, it generates a trend to restrict the rotation of the quick-release mechanism 100. At this point, the entire quick-release mechanism 100 cannot rotate along the ball head mechanism 300, thereby locking the camera mounted on the quick-release mechanism 100 and preventing 360° omnidirectional rotation. In this embodiment, the pressing block 210 has an L-shaped structure, and an assembly ring 200 is provided on the inner side of the pressing block. Both the inner and outer sides of the assembly ring 200 are formed with step surfaces. The inner step surface supports the clamping seat 120, while the outer step abuts against the inner side of the lower cover plate 310 of the ball head mechanism 300. The ball head mechanism 300 is fixedly connected to the lower cover plate 310 via bolts. Both the ball head mechanism 300 and the quick-release mechanism 100 can rotate along the assembly ring 200. However, when the pressing block 210 is forced to abut against the outer side of the assembly ring, it causes the pressing block 210 and the quick-release mechanism 100 to be locked and abutted, preventing rotation.

As shown in the figures, to achieve the restriction of the rotation trend of the quick-release mechanism 100 and complete the locking, it further includes a driving mechanism 320 passing through the clamping seat 120 and oriented toward the pressing block 210. The driving mechanism 320, during its axial inward movement, drives the pressing block 210 to rotate and be locked with the quick-release mechanism 100. Specifically, for example, using a screw as the driving mechanism, as the screw is tightened inward, the driving mechanism 320 directly presses against the pressing block 210. The inner side of the pressing block 210 is a sloped surface. During rotation of this sloped surface upward or downward, it abuts against the inner wall of the clamping seat 120 and the lower part abuts against the assembly ring 200, thereby preventing its rotation. Consequently, the camera can only take photos at a set position and cannot achieve 360° panoramic shooting.

The solution in this embodiment is applied to a camera, with the specific process as follows:

First, the quick-release function is introduced as follows:

1: A locking tongue 121 is slidably arranged horizontally left and right along the axis of the fixed seat formed by the clamping seat 120. A trigger block 130 is rotatably provided inside the locking tongue 121, and a locking protrusion is provided at the tail of the trigger block 130, which subsequently engages with the locking groove 144 on the rotating member 140 for locking matching.

2: To facilitate control of the locking of the rotating member, a rotating member 140 is also rotatably provided inside the clamping seat 120. A locking groove is opened on the rotating member 140 to cooperate with the locking protrusion at the tail of the trigger block 130, thereby controlling whether the rotating member 140 can rotate and be locked.

3: An arc-shaped protrusion is provided on the rotating member 140 to form an interference part 141. Then, on the lower part of the locking claw formed by the locking tongue 121, a step 1211 is provided to cooperate with the arc-shaped protrusion, thereby facilitating the subsequent linkage between rotational motion and axial horizontal linear motion.

4: To assist rotation, a first compression spring formed by a driving compression spring is rotatably arranged inside the clamping seat 120. One end of the driving compression spring abuts against the clamping seat 120, and the other end abuts against the rotating member 140, providing a driving force for the rotation of the rotating member 140.

5: The trigger block 130 is pressed down, and the locking protrusion disengages from the locking groove 144 of the rotating member. The rotating member 140 is unlocked and, under the action of the driving compression spring, pushes the locking claw to translate axially, i.e., the locking tongue moves horizontally along the axis to achieve locking.

Secondly, the control process for the gimbal and its combination with the ball head mechanism 300 to form panoramic functions is as follows:

In the prior art, a panoramic function is set for the camera: specifically, an assembly ring 200 is rotationally arranged inside the clamping seat 120 to enable 360° panoramic rotation of the camera.

To stop rotation at a set angle, a pressing block 210 is rotationally arranged inside the clamping seat 120. The pressing block has a L-shaped structure, with its axial direction perpendicular to that of the panoramic platform.

When locking is required, it simply needs to rotate the driving mechanism formed by the panoramic screw so that it abuts against the pressing block 210, enabling the pressing block 210 to contact the assembly ring 200, thereby locking the panoramic function.

To achieve this abutment, the contact surface between the pressing block 210 and the assembly ring 200 is inclined, further increasing the contact area and enhancing the locking effect.

The present disclosure can solve the problem of wobbling after the camera quick-release plate is assembled with the camera, while also preventing accidental triggering. The quick-release plate is stably assembled, easy to operate, provides a good user experience, and improves assembly efficiency.

In this embodiment, a through slot is provided on the clamping seat 120, and the rotating member 140 is arranged within the through slot. A grip part 145 is provided on the side of the rotating member 140. After the trigger block 130 is triggered, the entire control can be completed by manipulating the grip part 145 to rotate along the quick-release plate 110.

In the description of the present disclosure, it should be appreciated that directional terms such as “front, rear, up, down, left, right,” “traverse, vertical, perpendicular, horizontal” and “top, bottom,”, generally refer to the orientations or positional relationships shown in the accompanying drawings. They are used merely for convenience in describing the present disclosure and simplifying the description. Unless otherwise specified, these directional terms do not indicate or imply that the device or component referred to must have a specific orientation or be constructed and operated in a specific orientation, and thus should not be construed as limiting the scope of protection of the present disclosure; The directional terms “inner, outer” refer to inside and outside relative to the contour of each component itself.

For ease of description, spatial relative terms such as “on,” “above,” “on the upper surface of,” “upper,” may be used herein to describe the spatial relationship of one device or feature relative to other devices or features as illustrated in the drawings. It should be appreciated that spatial relative terms are intended to encompass different orientations of the device in use or operation, in addition to the orientation depicted in the drawings. For example, if a device in the drawings is inverted, a device described as being “above” or “on” other devices or structures would then be oriented as “below” or “under” the other devices or structures. Thus, the exemplary term “above” may encompass both “above” and “below” orientations. The device may also be oriented in other ways (rotated 90 degrees or at other orientations), and the spatial relative descriptions used herein should be interpreted accordingly.

Additionally, it should be noted that terms such as “first” and “second” are used to distinguish between components for clarity; unless otherwise stated, these terms do not imply any special meaning and should not be construed as limiting the scope of protection of the present disclosure.

The above description is only the preferred embodiment of the present disclosure and is not intended to limit the present disclosure. For those skilled in the art, the present disclosure may have various modifications and changes. Any modifications, equivalent substitutions and improvements made within the spirit and principles of the present disclosure shall be included within the protection scope of the present disclosure.

What is claimed is:

1. A quick-release mechanism, comprising a clamping seat, wherein a locking tongue is slidably provided at an end of the clamping seat, and the locking tongue is linked with a trigger block;
further comprising a rotating member rotatably arranged relative to the clamping seat, wherein a locking mechanism is provided between the clamping seat and the rotating member; and
further comprising a quick-release plate assembled on the clamping seat, wherein the quick-release plate, after being assembled, presses against the trigger block to release the locking mechanism, enabling the rotating member to rotate along the clamping seat, and during rotation of the rotating member, drives the locking tongue to translate axially.

2. The quick-release mechanism according to claim 1, wherein an assembly groove is formed in the middle of the locking tongue, and the trigger block is rotatably arranged within the assembly groove and reciprocates within a set range.

3. The quick-release mechanism according to claim 2, further comprising a rotating shaft passing through the trigger block, with both ends of the rotating shaft extending into the locking tongue, and the trigger block forming a lever structure with the rotating shaft as a fulcrum.

4. The quick-release mechanism according to claim 1, wherein the rotating member extends inward to form an interference part, the locking tongue extends downward to form a step, and during rotation of the rotating member, the interference part generates an interference force that pushes the step to move axially.

5. The quick-release mechanism according to claim 4, wherein, along a circumferential direction of the rotating member, from one end to the other, the interference force of the interference part shows a trend of gradually increasing or decreasing.

6. The quick-release mechanism according to claim 4, further comprising a first compression spring abutting against the clamping seat and the rotating member respectively, the first compression spring forming a driving force that drives the rotating member to rotate.

7. The quick-release mechanism according to claim 6, further comprising a second compression spring abutting against the locking tongue and the clamping seat respectively, the second compression spring forming a driving force that drives the locking tongue to move axially outward.

8. The quick-release mechanism according to claim 1, wherein one of the trigger block and the rotating member is provided with a locking hook, and the other is provided with a locking groove.

9. The quick-release mechanism according to claim 1, further comprising a locking tongue cover plate fixed on the clamping seat, wherein a sliding trajectory for axial sliding of the locking tongue is formed on the locking tongue cover plate.

10. A quick-release mechanism, comprising a clamping seat, wherein a locking tongue is slidably provided at an end of the clamping seat, and the locking tongue is linked with a trigger block;
further comprising a rotating member, wherein a locking mechanism is provided between the clamping seat and the rotating member; and
further comprising a quick-release plate assembled on the clamping seat, the quick-release plate being used to release the locking mechanism, causing the locking tongue to move axially.

11. The quick-release mechanism according to claim 10, wherein the rotating member is rotatably arranged on the clamping seat.

12. The quick-release mechanism according to claim 11, wherein after being assembled, the quick-release plate presses against the trigger block to release the locking mechanism, thereby enabling the rotating member to rotate relative to the clamping seat.

13. The quick-release mechanism according to claim 12, wherein the rotating member extends inward to form an interference part, the locking tongue extends downward to form a step, and during rotation of the rotating member, the interference part generates an interference force that pushes the step to move axially.

14. The quick-release mechanism according to claim 13, wherein the rotating member interferes with the locking tongue during rotation to drive the locking tongue to translate axially.

15. A gimbal, comprising a quick-release mechanism and a ball head mechanism, as well as an assembly ring rotatably connected to the quick-release mechanism, wherein the assembly ring is fixedly connected to the ball head mechanism.

16. The gimbal according to claim 15, further comprising a driving mechanism,
wherein the quick-release mechanism comprises a clamping seat, and the driving mechanism is provided with a pressing block extending into the clamping seat.

17. The gimbal according to claim 16, wherein the driving mechanism is oriented toward the pressing block and passes through the clamping seat, and during an axial inward movement, the driving mechanism drives the pressing block to rotate and be locked with the quick-release mechanism; and
during rotation under a force, the pressing block generates a trend to restrict rotation of the quick-release mechanism.

18. The gimbal according to claim 16, wherein a locking tongue is slidably provided at an end of the clamping seat, and the locking tongue is linked with a trigger block;
the gimbal further comprises a rotating member rotatably arranged relative to the clamping seat, and a locking mechanism is provided between the clamping seat and the rotating member; and
the gimbal further comprises a quick-release plate assembled on the clamping seat, and the quick-release plate, after being assembled, presses against the trigger block to release the locking mechanism, enabling the rotating member to rotate along the clamping seat and during rotation of the rotating member, drives the locking tongue to translate axially.

19. The gimbal according to claim 18, wherein an assembly groove is formed in the middle of the locking tongue, and the trigger block is rotatably arranged within the assembly groove and reciprocates within a set range; and
the gimbal further comprises a rotating shaft passing through the trigger block, with both ends of the rotating shaft extending into the locking tongue, and the trigger block forms a lever structure with the rotating shaft as a fulcrum;
the rotating member extends inward to form an interference part, the locking tongue extends downward to form a step, and during rotation of the rotating member, the interference part generates an interference force that pushes the step to move axially;
along a circumferential direction of the rotating member, from one end to the other, the interference force of the interference part shows a trend of gradually increasing or decreasing;
the gimbal further comprises a first compression spring respectively abutting against the clamping seat and the rotating member, and the first compression spring forms a driving force that drives the rotating member to rotate; and
the gimbal further comprises a second compression spring respectively abutting against the locking tongue and the clamping seat, and the second compression spring forms a driving force that drives the locking tongue to move axially outward.

20. The gimbal according to claim 19, wherein, one of the trigger block and the rotating member is provided with a locking hook, and the other is provided with a locking groove; and
the gimbal further comprises a locking tongue cover plate fixed on the clamping seat, and a sliding trajectory for axial sliding of the locking tongue is formed on the locking tongue cover plate.
